(19) United States
(12) Patent Application Publication
(10) Pub. No.: US 2010/0321342 A1
(43) Pub. Date: Dec. 23, 2010

(54) OPTICAL TOUCHPAD DEVICE

(75) Inventor: CHUN-YU LEE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/778,131

(22) Filed: May 12, 2010

(30) Foreign Application Priority Data
Jun. 19, 2009 (CN) 200910303456.4

(51) Int. Cl. G06F 3/042

(52) U.S. Cl. 345/175; 345/104

(57) ABSTRACT

An optical touchpad device includes an LCD display module having a light output surface for outputting a linearly polarized light, a sensor, and an image capturing module. The sensor is disposed in front of the light output surface, transparent, and of being anisotropy when a pressure is applied thereon; the image capturing module has a polarizer whose polarization direction is perpendicular to that of the linearly polarized light, wherein, the linearly polarized light transmits through the sensor when the pressure applied upon the sensor, double refracts to two bundles of light with different vibration directions according to the pressure, and forms an interference image which is then captured by the image capturing module after the two bundles of light transmitting through the polarizer, thereby coordinates of a position of the senor where an user applies the pressure at can be calculated.

### BACKGROUND

1. Technical Field

The disclosure relates to touch devices, and particularly to an optical touchpad device and electronic devices employing the optical touchpad device.

2. Description of Related Art

Current optical touchpad device is usually installed in the liquid crystal display and using infrared light. The multipoint touching device of liquid crystal screen is already known. A multipoint touching device includes a touch panel, an infrared LED, an infrared camera, and a processor. The infrared LED is mounted on the circumference of the touch panel, all infrared light is contained by utilizing the total internal reflection principle. When an object touches the touch panel, the total internal reflection is broken, and the infrared camera at the rear of the panel can seize the bright spot. An infrared filter is added in the front of the infrared camera to filter visible light. The touch panel records a touch event, and transmits touch signals to a controller, the controller processes the touch signal, and transmits the data of the touch event and a touch position to the processor to identify the touch and execute operations based on the touch operation. However, this approach has disadvantages that it requires the installation of infrared light source, which will increase the cost.

Therefore, it is useful to provide an optical touchpad device to overcome the above-mentioned shortcoming.

### BRIEF DESCRIPTION OF THE DRAWINGS

The components in the drawing are not necessarily drawn to scale, the emphasis instead being placed upon clearly illustrating the principles of the optical touchpad device.

FIG. 1 is a front view of an optical touchpad device in accordance with an exemplary embodiment.

FIG. 2 is a schematic view of an image capturing module of the optical touchpad device of FIG. 1.

FIG. 3 is a cross-sectional view of a LCD display module of the optical touchpad device in accordance with a first exemplary embodiment.

FIG. 4 is an isometric view of a LCD display module of the optical touchpad device in accordance with a second exemplary embodiment.

FIG. 5 is a cross-sectional view of a LCD display module of the optical touchpad device in accordance with a third exemplary embodiment.

### DETAILED DESCRIPTION

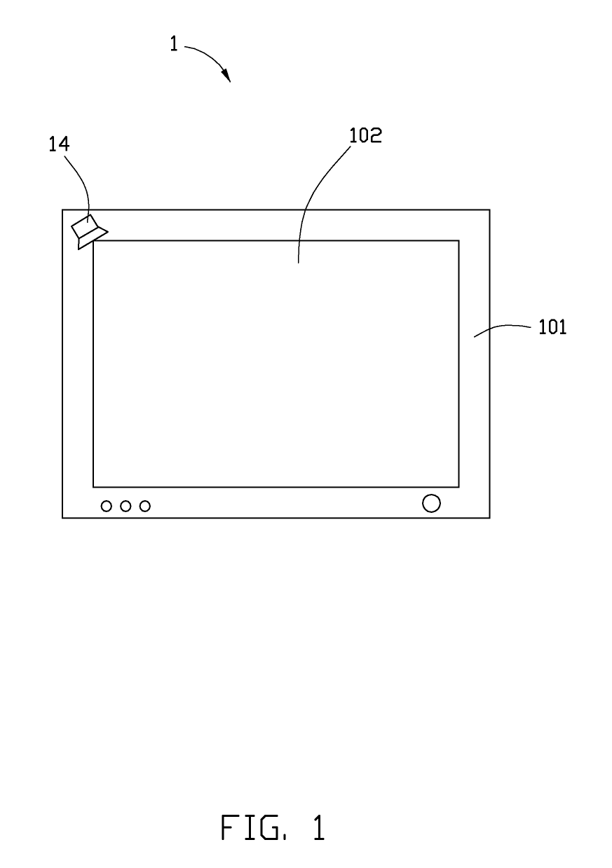

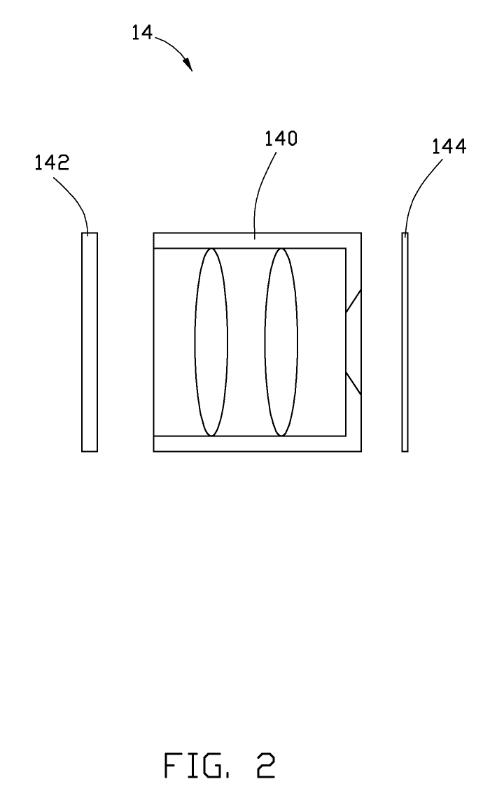

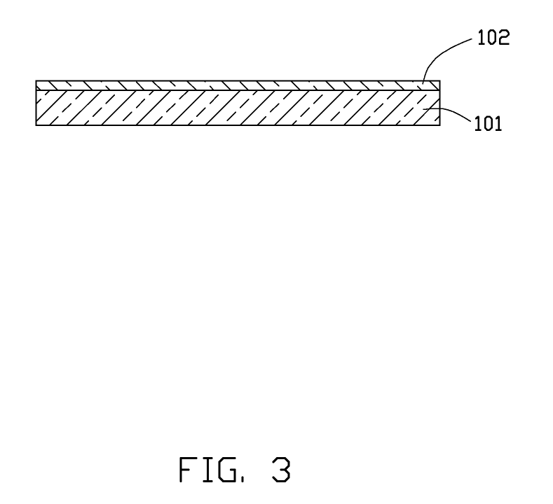

Referring to FIGS. 1-3, an optical touchpad device 1 includes an LCD display module 101, a sensor 102 and an image capturing module 14.

The LCD display module 101 is a LCD display. The sensor 102 is a thin sheet made of isotropic material, and packaged with the LCD display module 101. The sensor 102 is arranged in front of the LCD display module 101. The size of the sensor 102 is the same with that of the light output surface of the LCD display module 101. As the LCD display module 101 includes two pieces of polarizers (not shown), the output light is linearly polarized light.

The sensor 102 is transparent and of being anisotropy when a pressure is applied thereon, and has double refraction when incident polarized light is applied.

The image capturing module 14 includes a camera lens 140, an image sensor 142 and a polarizer 144. The polarization direction of the polarizer 144 is perpendicular to that of the output light of the LCD display module 101. The image capturing module 14 disposed above the LCD display module 101, for example, on an upper corner of the bezel of the LCD display module 101. The image capturing module 14 is arranged in such a way to have a proper field of view (FOV) for the light output surface of the LCD display module 10.

When the LCD display module 101 is working, the image capturing module 14 does not receive light from the LCD display module 101. That is because the polarization direction of the polarizer 144 is perpendicular to the polarization direction of the output light of the LCD display module 101, the polarizer 144 prevents light from entering the camera lens 140 and the image sensor 142.

When a user touches the sensor 102, the sensor 102 generates stress corresponding to the touching. The output light from the LCD display module 101 double refracts to two bundles of light with different vibration directions according to the stress. The two bundles of light interferes though the polarizer 144, thereby forming an interference image in range of the image capturing module 14. The interference image represents distribution of stress: where interference stripe of the interference image is denser, the stress is higher. The position where the stress is highest is the touch point, thereby the coordinates of the touching position can be calculated.

Similar to a single touch, when a continuous touch movement is applied to the sensor 102, the interference images changes continuously. Moving track of the continuous touch movement can be obtained by recording all positions where the stress is highest in each interference image. The optical touchpad device 1 could only use the output light of the LCD display module 101, without other light, for example, infrared light.

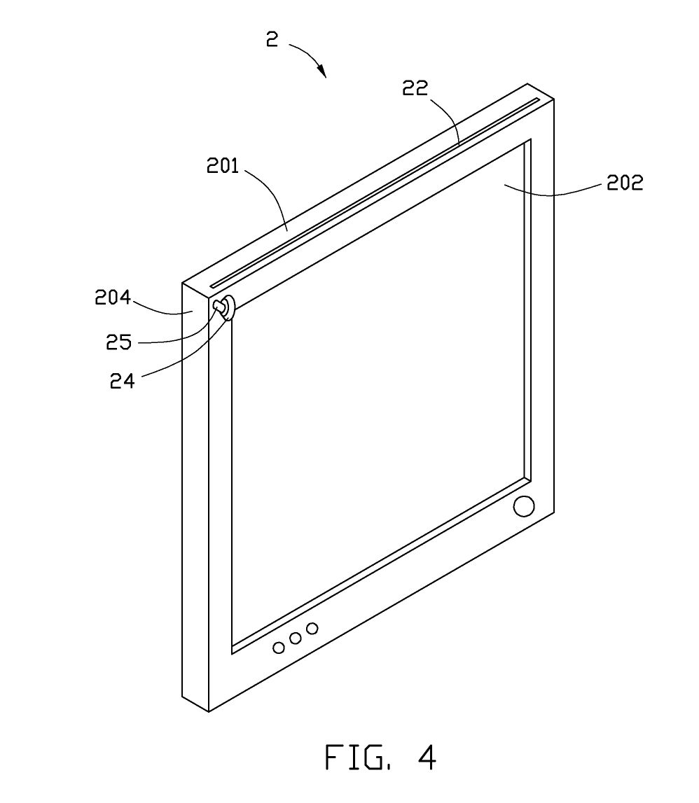

Referring to FIG. 4, similar to the optical touchpad device 1, an optical touchpad device 2 includes an LCD display module (not shown), a sensor 202 and an image capturing module 24. The image capturing module 24 is arranged above the LCD display module by a supporting rod 25, and face the light output surface. The sensor 202 is made of isotropic material, the size of the sensor 202 is same to the size of the LCD display module.

Differently from the first embodiment of the present disclosure, the sensor 202 is not packaged with the LCD display module. The optical touchpad device 2 further includes a frame 204. The LCD display module and the sensor 202 are enclosed in the frame 204. A slot 22 is formed in an upper surface 201 of the frame 204. The sensor 202 can thus pass through the slot 22 to be retained within the frame 204 in front of the light output surface of the LCD display module. The slot 22 is shaped to have a proper size for ease of inserting of the sensor 202. The sensor 202 may be glued to the frame 204 for easy repalcing. The slot 22 may be formed in the left or right side or the lower surface of the frame 204.

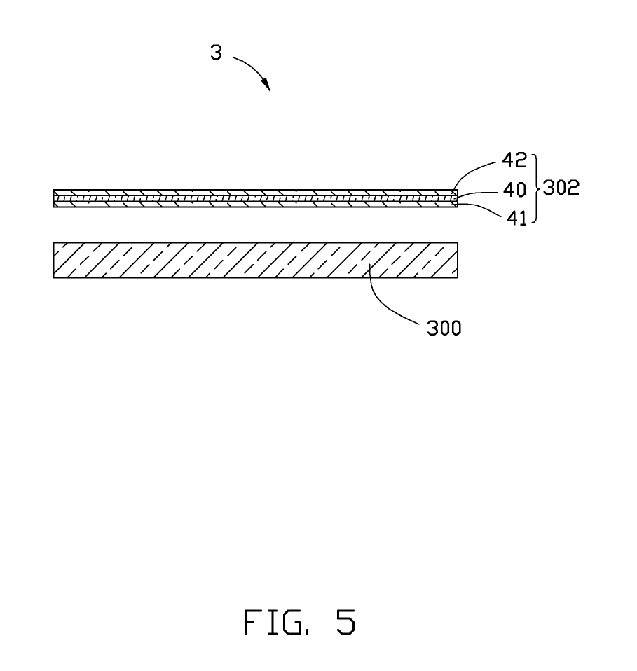

Referring to FIG. 5, similarly to the optical touchpad device 1, an optical touchpad device 3 includes an LCD display module 300, a sensor 302 and an image capturing module (not shown). The sensor 302 includes a first sensing layer 41, a second sensing layer 42, and an LCD layer 40 packaged between the first sensing layer 41 and the second sensing layer 42. The size of the sensor 302 is the same to the light output surface of the LCD display module 300.

The first sensing layer 41 and the second sensing layer 42 are made of isotropic material. The sensor 302 may be packaged together with the LCD display module 300 and fixed to the light output surface of the LCD display module 300 without space, or the light output surface of the LCD display module 300 separately with space.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An optical touchpad device comprising:
an LCD display module having a light output surface for outputting a linearly polarized light, a sensor, and an image capturing module,
the sensor being disposed in front of the light output surface, transparent, and of being anisotropy when a pressure is applied thereon;
the image capturing module having a polarizer whose polarization direction is perpendicular to that of the linearly polarized light, wherein,
the linearly polarized light transmits through the sensor when the pressure applied upon the sensor, double refracts to two bundles of light with different vibration directions according to the pressure, and forms an interference image which is then captured by the image capturing module after the two bundles of light transmitting through the polarizer, thereby coordinates of a position of the senor where an user applies the pressure at can be calculated.

2. The optical touchpad device of claim 1, wherein the sensor is made of isotropic material, and the size of the sensor is the same as that of the LCD display module.

3. The optical touchpad device of claim 1, wherein the sensor is packaged together with the LCD display module.

4. The optical touchpad device of claim 1, wherein the optical touchpad device further comprises a frame, the LCD display module and the sensor are enclosed in the frame, a slot is disposed on the frame, and shaped to have a proper size for ease of inserting of the sensor and covering the light output surface of the LCD display module.

5. The optical touchpad device of claim 1, wherein the sensor further comprises a first sensing layer, a second sensing layer, and an LCD layer packaged between the first sensing layer and the second sensing layer.

6. The optical touchpad device of claim 5, wherein the optical touchpad device further comprises a frame, the LCD display module and the sensor are enclosed in the frame, a slot is disposed on the frame, and shaped to have a proper size for ease of inserting of the sensor and covering the light output surface of the LCD display module.

7. The optical touchpad device of claim 1, wherein the image capturing module is disposed above the LCD display module, and face the light output surface.

8. The optical touchpad device of claim 1, wherein the LCD display module further comprises two pieces of polarizers.

9. The optical touchpad device of claim 1, wherein the image capturing module is arranged to have a proper field of view for the light output surface of the LCD display module.

10. The optical touchpad device of claim 1, wherein the interference image represents distribution of stress where the denser an interference stripe of the interference image, the higher the stress.

11. The optical touchpad device of claim 10, wherein the position where the stress is highest is the touch point, thereby the coordinates of the position can be calculated.

12. The optical touchpad device of claim 10, wherein when a continuous touch movement is applied to the sensor, the interference images changes continuously, a moving track of the continuous touch movement can be obtained by recording all positions where the stress is the highest in each interference image.
